(19) United States
(12) Patent Application Publication
(10) Pub. No.: US 2015/0178689 A1
(43) Pub. Date: Jun. 25, 2015

(54) INTERACTIVE TIME MANAGEMENT TOOL

(71) Applicant: Pierre Marcotte, Quebec (CA)

(72) Inventor: Pierre Marcotte, Quebec (CA)

(73) Assignee: SOCIETE PAR ACTIONS ARANATHA, Quebec (CA)

(21) Appl. No.: 14/406,563

(22) PCT Filed: Jun. 27, 2012
(86) PCT No.: PCT/CA2012/050431

§ 371 Date: Dec. 9, 2014

(51) Int. Cl. G06Q 10/10

(52) U.S. Cl. CPC G06Q 10/1095

(57) ABSTRACT

There is described herein an interactive time management tool. A calendar view is presented showing scheduled events on a daily, weekly, monthly, and/or yearly basis. A visual representation, such as an icon, is available for selection in combination with a previously scheduled event to cause the event to automatically be moved from its original time slot to a time slot corresponding to an actual or present time slot. The calendar is therefore updated in real time using minimal effort in order to more accurately represent how a user's time was spent over a given period of time.

### CROSS-REFERENCE TO RELATED APPLICATIONS

This is the first application filed for the present invention.

### TECHNICAL FIELD

The present invention relates to the field of electronic time management tools and more particularly, to dynamic tools that can adapt to changes in the events of a day interactively.

### BACKGROUND OF THE ART

Most time management software tools provide at least an electronic version of a calendar, as well as an appointment book, an address book, and a contact list. With the proliferation of handheld devices such as smartphones and tablets, many additional features are also offered, such as appointment attachments and reminders, availability sharing, group calendars, collaborative scheduling, calendar publishing, and web-based interfaces. While some of these features may be more useful than others, they are certainly an indication of the growing need to improve on existing technologies related to time management and the desire to minimize the efforts required to keep track of everything one has to get done during a given period of time.

### SUMMARY

There is described herein an interactive time management tool. A calendar view is presented showing scheduled events on a daily, weekly, monthly, and/or yearly basis. A visual representation, such as an icon, is available for selection in combination with a previously scheduled event to cause the event to automatically be moved from its original time slot to a time slot corresponding to an actual or present time slot. The calendar is therefore updated in real time using minimal effort in order to more accurately represent how a user's time was spent over a given period of time.

The visual representation has a time component that always corresponds to an actual or present time and is correlated with a time slot in the calendar view that matches the actual time. Therefore, any association between the visual representation and a given event will transfer the time component of the visual representation to the event, causing the event to be displaced from its original time slot to a “now” time slot.

In accordance with a first broad aspect, there is provided an interactive time management system comprising a processor in a computer system, a memory accessible by the processor, and at least one application stored in the memory. The application has program code executable by the processor for: receiving as input an identification of a previously scheduled event in a calendar view of an electronic calendar; determining in real time a current time; identifying a current time slot in the calendar view corresponding to the current time; and generating a displacement instruction to displace the previously scheduled event in the calendar view to the current time slot.

In accordance with a second broad aspect, there is provided a computer-implemented method for interactive time management of an electronic calendar comprising execution of program code for: receiving as input an identification of a previously scheduled event in a calendar view of the electronic calendar; determining in real time a current time; identifying a current time slot in the calendar view corresponding to the current time; and generating a displacement instruction to displace the previously scheduled event in the calendar view to the current time slot.

In accordance with a third broad aspect, there is provided a computer readable medium having stored thereon program code executable by a processor for interactive time management of an electronic calendar, the program code executable for: receiving as input an identification of a previously scheduled event in a calendar view of the electronic calendar; determining in real time a current time; identifying a current time slot in the calendar view corresponding to the current time; and generating a displacement instruction to displace the previously scheduled event in the calendar view to the current time slot.

In this specification, the term “visual representation” is intended to mean any image, picture, logo, or text that may be recognized by a user as having the function as described herein. The term “previously scheduled event” is intended to mean an event that has been scheduled to take place in the future or that lingers from a past time period and remains incomplete.

### BRIEF DESCRIPTION OF THE DRAWINGS

Further features and advantages of the present invention will become apparent from the following detailed description, taken in combination with the appended drawings, in which:

FIG. 1 is an exemplary diagram of a system for executing an interactive time management tool;

FIG. 2 is an exemplary embodiment of a client device or server from the system of FIG. 1, for implementing the interactive time management tool;

FIG. 3 is an exemplary block diagram of the interactive time management tool;

FIGS. 4a to 4c are exemplary screenshots illustrating displacing a previously scheduled event from an original time slot to a present time slot by dragging and dropping a visual representation;

FIGS. 5a to 5c are exemplary screenshots illustrating displacing a previously scheduled event from a weekly time period to a present time slot;

FIGS. 6a to 6c are exemplary screenshots illustrating displacing a previously scheduled event of a first duration to a present time slot of a second duration shorter than the first duration;

FIGS. 7a to 7c are exemplary screenshots illustrating displacing a previously scheduled event by selecting an item in a menu associated with the previously scheduled event;

FIG. 8 is an exemplary screenshot illustrating scheduled events each having a visual representation associated thereto;

FIG. 9a is an exemplary embodiment of a real time updating module from the interactive time management tool;

FIG. 9b is an exemplary embodiment of a calendar module from the interactive time management tool;

FIG. 10 is an exemplary embodiment of a time unit from the real time updating module.

It will be noted that throughout the appended drawings, like features are identified by like reference numerals.

### DETAILED DESCRIPTION

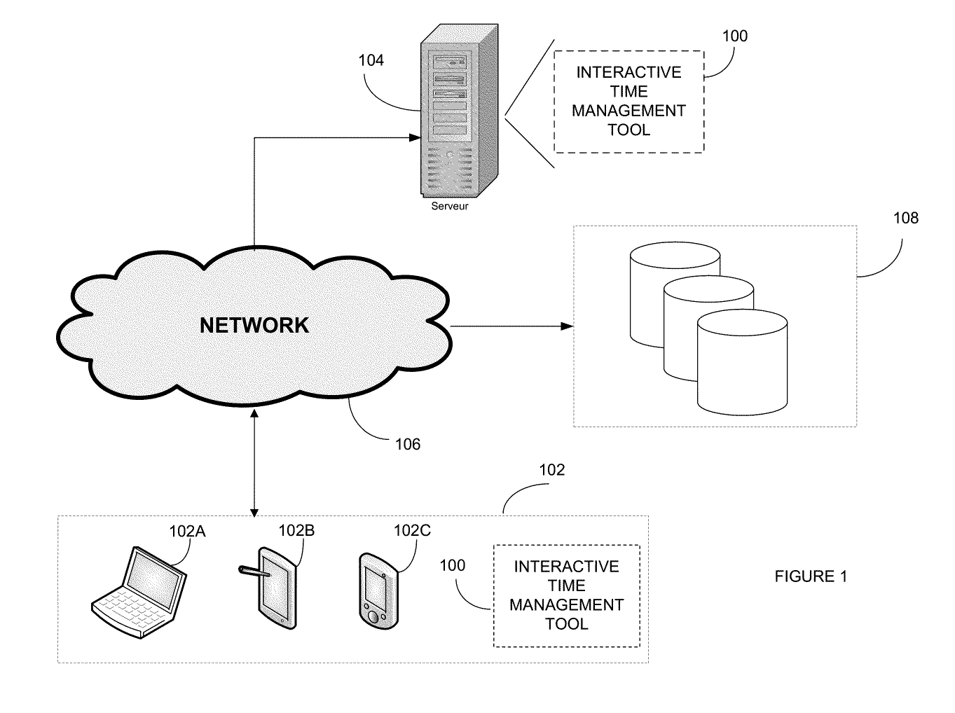

Referring to FIG. 1, there is illustrated a system for executing an interactive time management tool 100. In one embodiment, the interactive time management tool 100 is provided locally on a client device 102, such as a computer 102a, a tablet 102b, a smartphone 102c, etc. Alternatively, part or all of the interactive time management tool 100 may be provided on one or more server(s) 104 remotely from the client device 102 and accessible via a network 106. For example, a series of servers corresponding to a web server, an application server, and a database server may be used. These servers are all represented by server 104 in FIG. 1. The network 106 may be any type of public and/or private network such as the Internet, the Public Switch Telephone Network (PSTN), a cellular network, or others known to those skilled in the art. One or more databases 108 may be integrated directly into the server 104 or may be provided separately and remotely therefrom. In the case of a remote access to the databases 108, access may occur via any type of network 106, as indicated above. The network 106 for access to the databases 108 may be the same or different from that used by the client device 102 to access the remote server 104.

The various databases 108 described herein may be provided as collections of data or information organized for rapid search and retrieval by a computer. They are structured to facilitate storage, retrieval, modification, and deletion of data in conjunction with various data-processing operations. They may consist of a file or sets of files that can be broken down into records, each of which consists of one or more fields. Database information may be retrieved through queries using keywords and sorting commands, in order to rapidly search, rearrange, group, and select the field. The databases 108 may be any organization of data on a data storage medium, such as one or more servers. In one embodiment, the databases 108 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). An SSL session may be started by sending a request to the Web server with an HTTPS prefix in the URL, which causes port number “443” to be placed into the packets. Port “443” is the number assigned to the SSL application on the server. Identity verification of a user may be performed using usernames and passwords for all users. Various levels of access rights may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

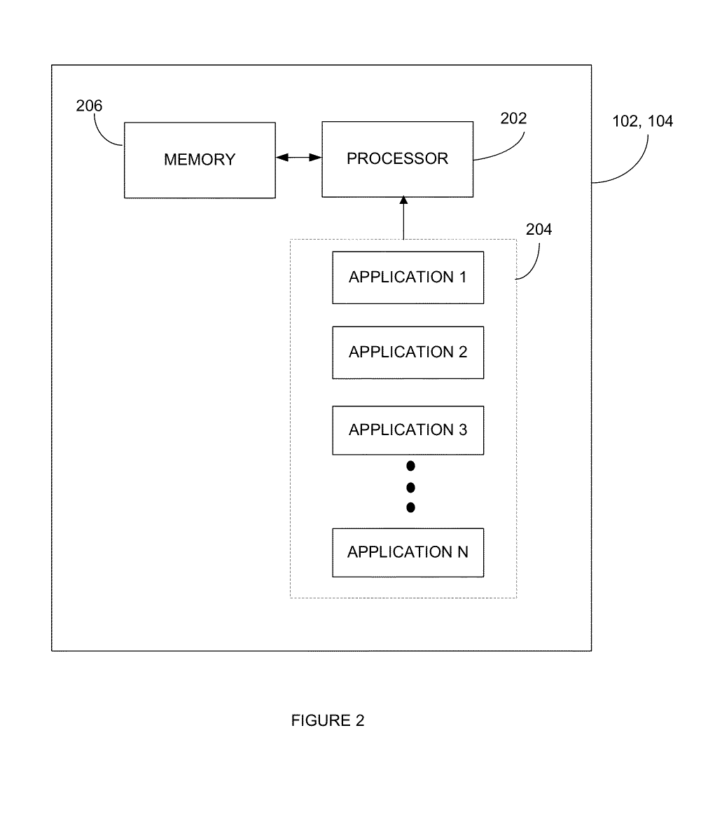

FIG. 2 is an exemplary embodiment of the server 104 and/or client device 102 and comprises, amongst other things, a plurality of applications 204 running on a processor 202, the processor being coupled to a memory 206. In one exemplary embodiment, the application is running on remote server 104 and is available as a web-based application. In another exemplary embodiment, the application is running in part on remote server 104 and in part on client device 102. It should be understood that while the applications 204 presented herein are illustrated and described as separate entities, they may be combined or separated in a variety of ways.

The memory 206 accessible by the processor 202 receives and stores data. The memory 206 may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc. The processor 202 may access the memory 206 to retrieve data. The processor 202 may be any device that can perform operations on data. Examples are a central processing unit (CPU), a front-end processor, a microprocessor, a graphics processing unit (GPU/VPU), a physics processing unit (PPU), a digital signal processor, and a network processor. The applications 204 are coupled to the processor 202 and configured to perform various tasks as explained below in more detail. An output may be transmitted to the client device 102.

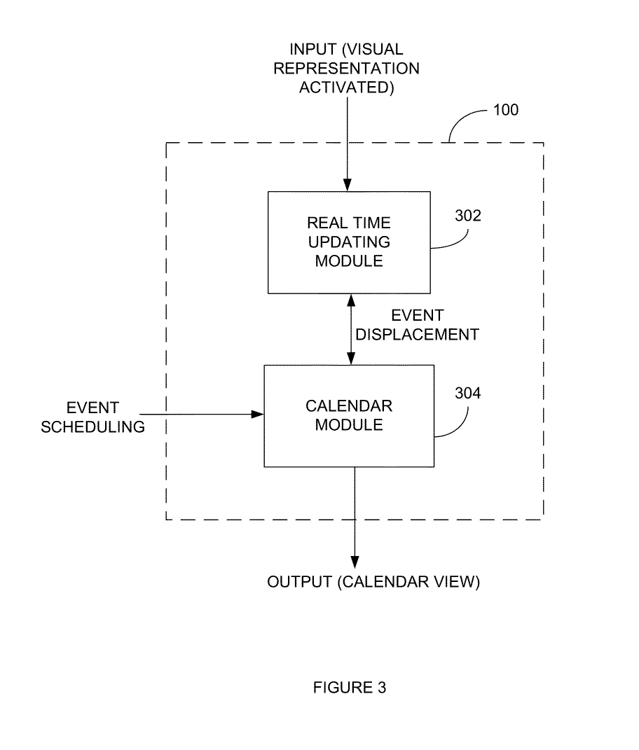

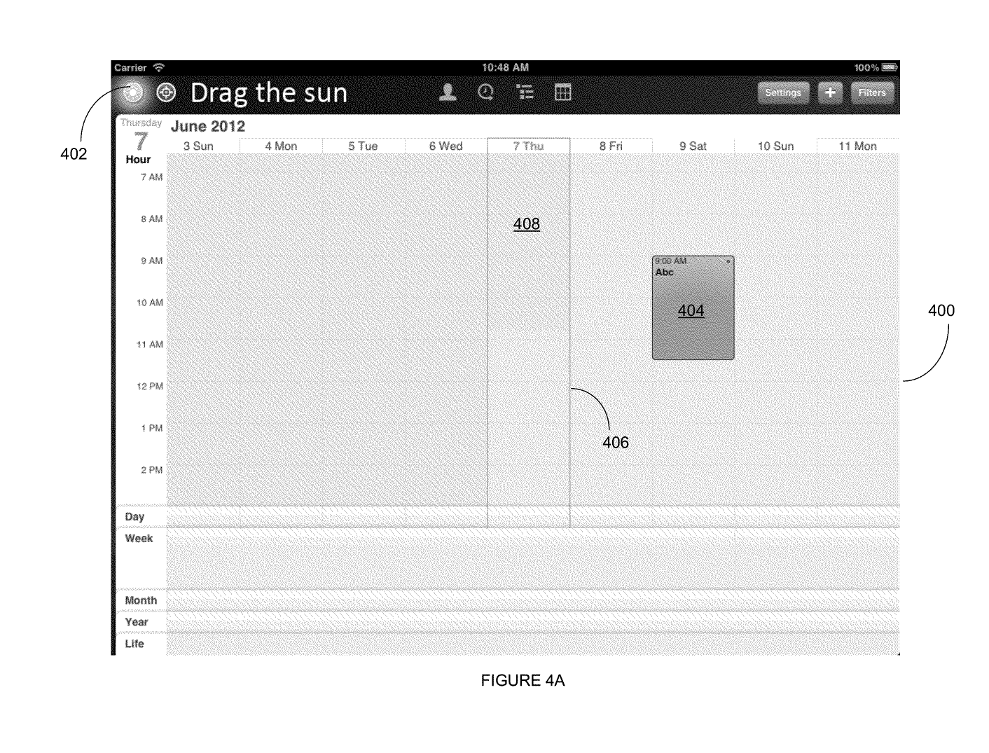

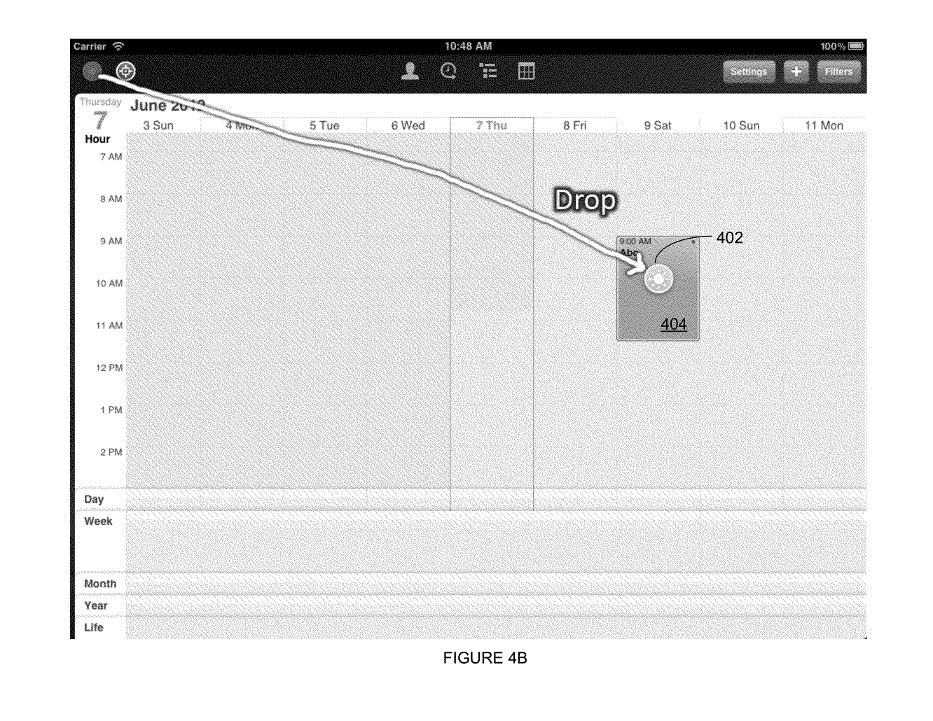

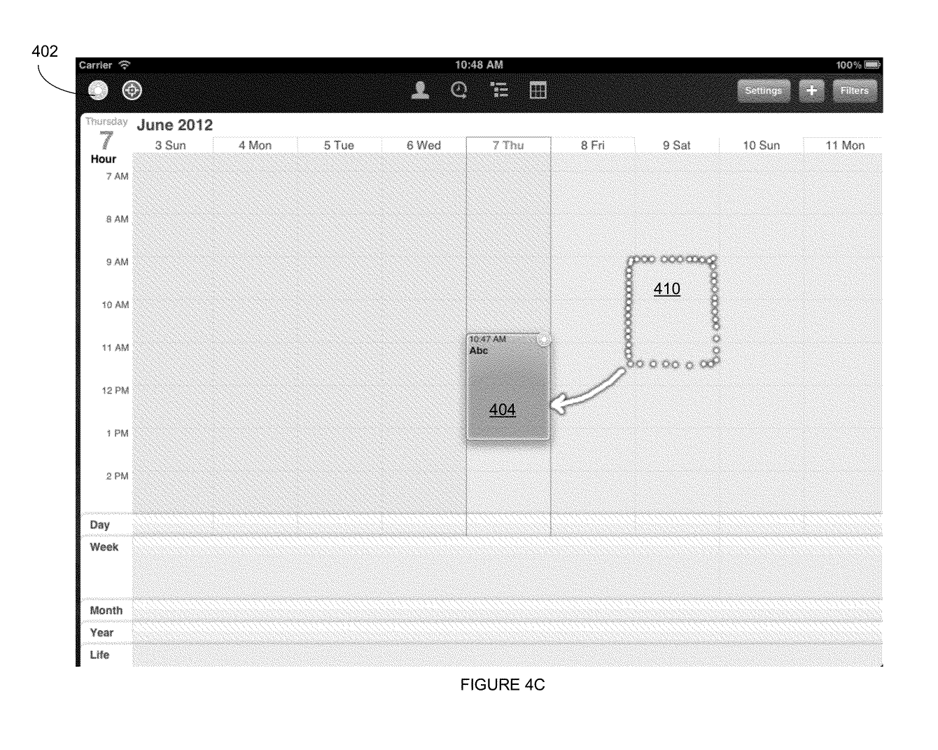

Referring now to FIG. 3, there is illustrated an exemplary embodiment for the interactive time management tool 100, as embodied by one or more applications 204 running on the processor 202 of the client device 102 and/or the remote server 104. A real time updating module 302 interacts with a calendar module 304. The calendar module 304 may be any existing or known electronic calendar application, such as Microsoft Outlook™, Schedule+™, Exchange Client™, Google Calendar™, and iCal™. Alternatively, the calendar module 304 may be a custom-designed calendar module providing known electronic calendar features such as event scheduling on a daily, weekly, monthly, and/or yearly basis. A calendar view, such as that illustrated in FIG. 4a, is displayed to a user on an output display (not shown) of a client device 102. The real time updating module 302 manages the dynamic interaction the user has with a visual representation, as will be explained in more detail below.

As per the screen shot illustrated in FIG. 4a, a calendar view 400 is provided for a given period of time. In this example, a nine day period is illustrated, each day broken down into time slots of a given duration. An exemplary event 404 is scheduled to take place between 9:00am and 11:30am on Saturday Jun. 9, 2012. An outline 406 indicates that the present day is Thursday Jun. 7, 2012. The shading 408 of the upper portion of outline 406 indicates that the present time is almost 11:00am.

A visual representation 402, such as an icon, is available for selection and manipulation by the user for updating or modifying a previously scheduled event dynamically. The visual representation 402 is illustratively provided as an image of a sun in the top left corner of the calendar view 400. Other locations and/or representations for the visual representation 402 will be readily understood by those skilled in the art. Also illustratively, and as shown in FIG. 4b, the visual representation 402 may be dragged and dropped to a previously scheduled event, such as event 404. Dropping the visual representation 402 onto the event 404 creates an association between the former and the latter. The visual representation 402 has a time component that always corresponds to an actual or present time and is correlated with a time slot in the calendar view 400 that matches the actual time. Therefore, the association between the visual representation 402 and the event 404 will transfer the time component of the visual representation 402 to the event 404, causing the event 404 to be displaced from its original time slot 410 to a “now” time slot, as illustrated in FIG. 4c. Once event 404 has been moved to a new time slot, the visual representation 402 may reappear at its initial position, ready to be used again by the user.

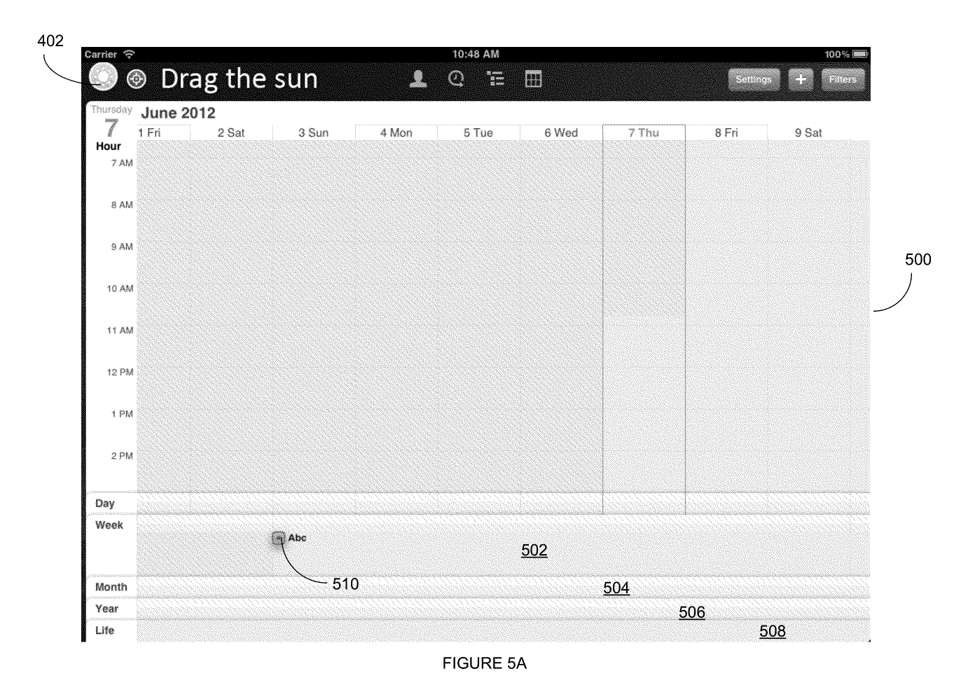

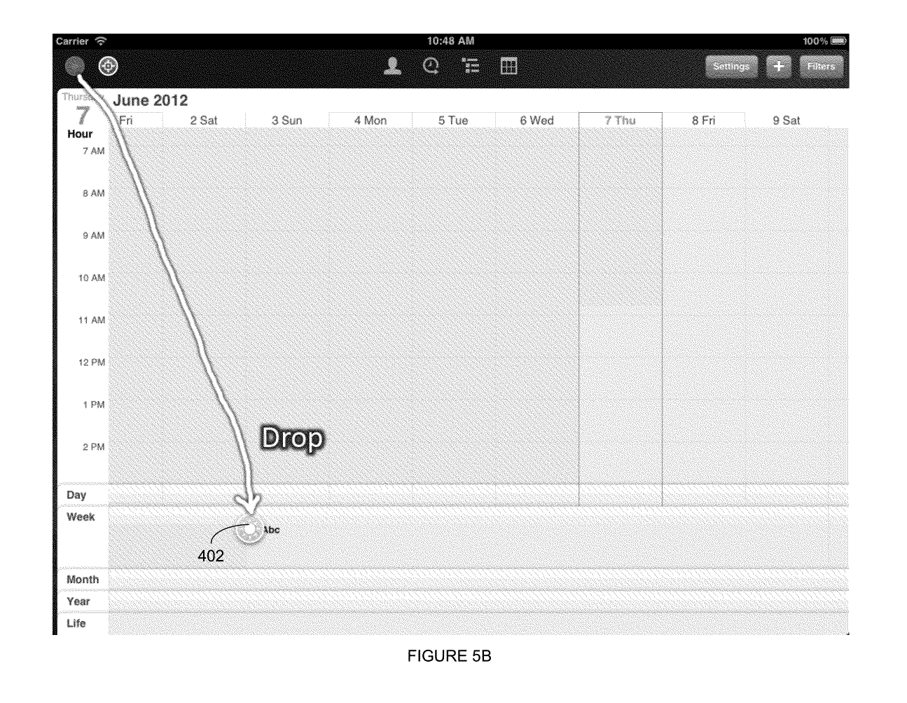

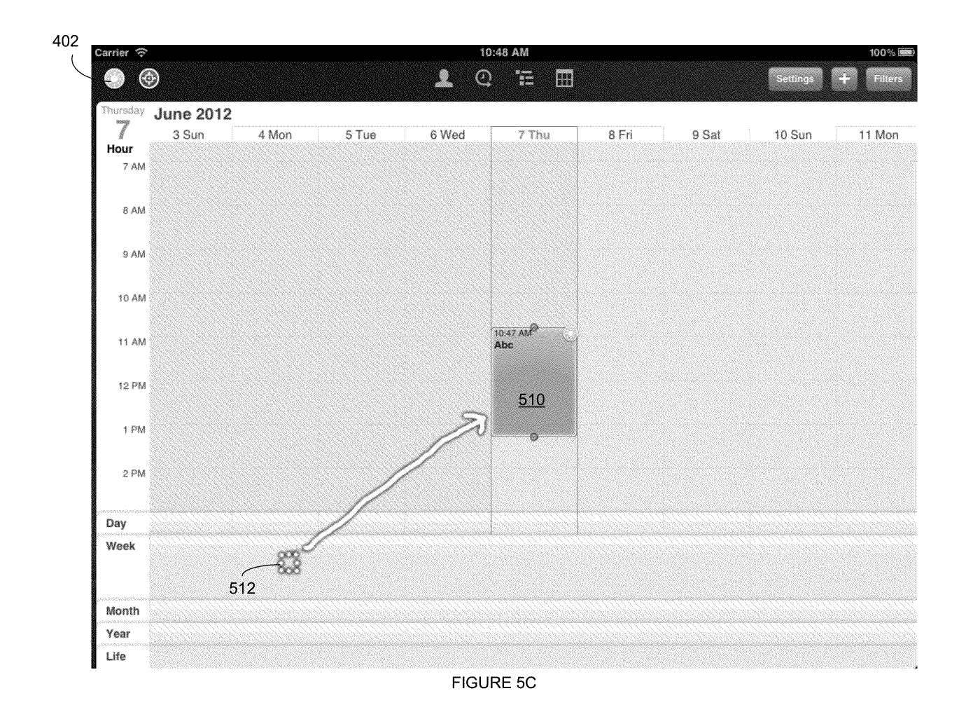

FIG. 5a illustratively shows a calendar view 500 for a period running from Jun. 1, 2012 to Jun. 9, 2012. In addition to having individual time slots for each day, a time slot is also illustratively presented for a week 502, a month 504, a year 506, and a lifetime 508. The user may schedule events to take place during any one of these defined time periods, without needing to specify more precisely at which point in time within the given time period the event is to take place. Event 510 is exemplarily scheduled to occur during the present week. As per FIG. 5b, the visual representation 402 may be dragged and dropped on top of event 510. As per FIG. 5c, this causes event 510 to be moved from its original slot 512 to a time slot corresponding to an actual time. The visual representation 402 may be dragged and dropped on top of a previously scheduled event in anyone of the week 502, month 504, year 506, and life 508 time periods and have it be automatically displaced to a time slot corresponding to an actual time.

Events scheduled in the week 502, month 504, year 506, and life 508 time periods may or may not have a predefined duration, such as 30 minutes, 1 h 15, 2 h 00, etc. If it already has a duration associated thereto, the event may be moved into a time slot of the predefined duration. If the event does not have a predefined duration, it may be moved into a time slot of a duration equal to an available time between a present time and a next scheduled event. Alternatively, the event may be moved into a time slot of a default duration, such as 30 minutes, one hour, two hours, or any other duration as set by a user and/or configured into the system.

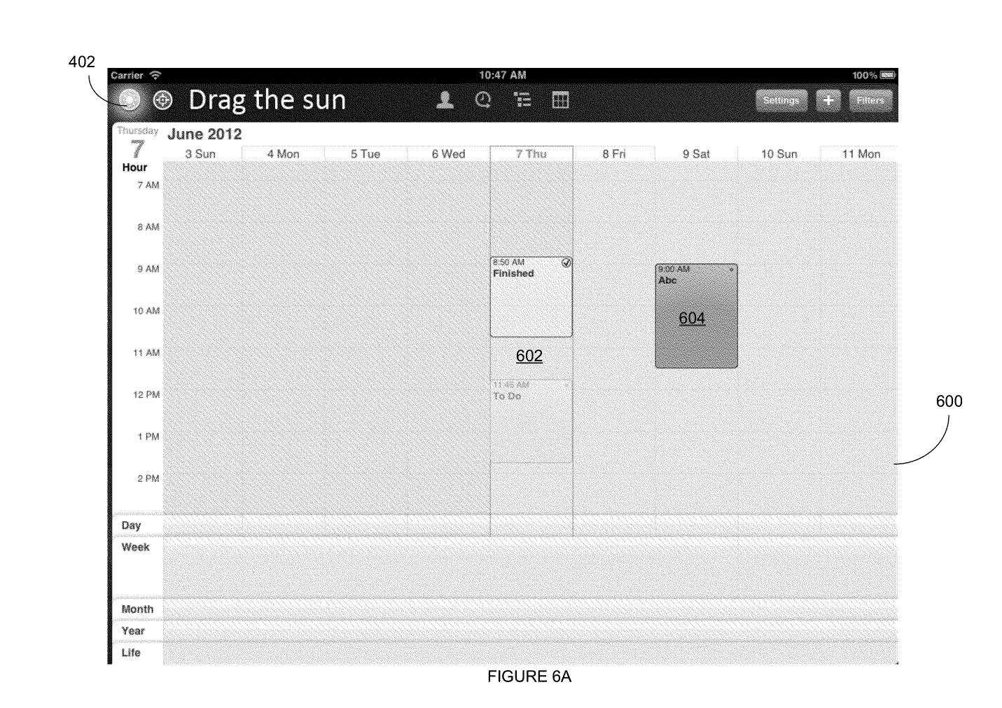

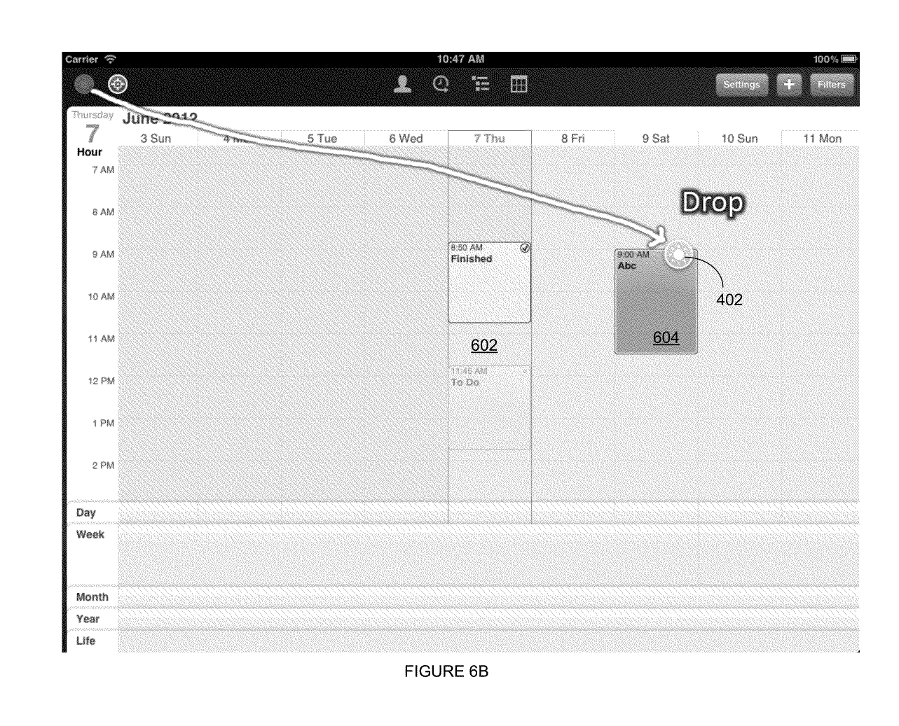

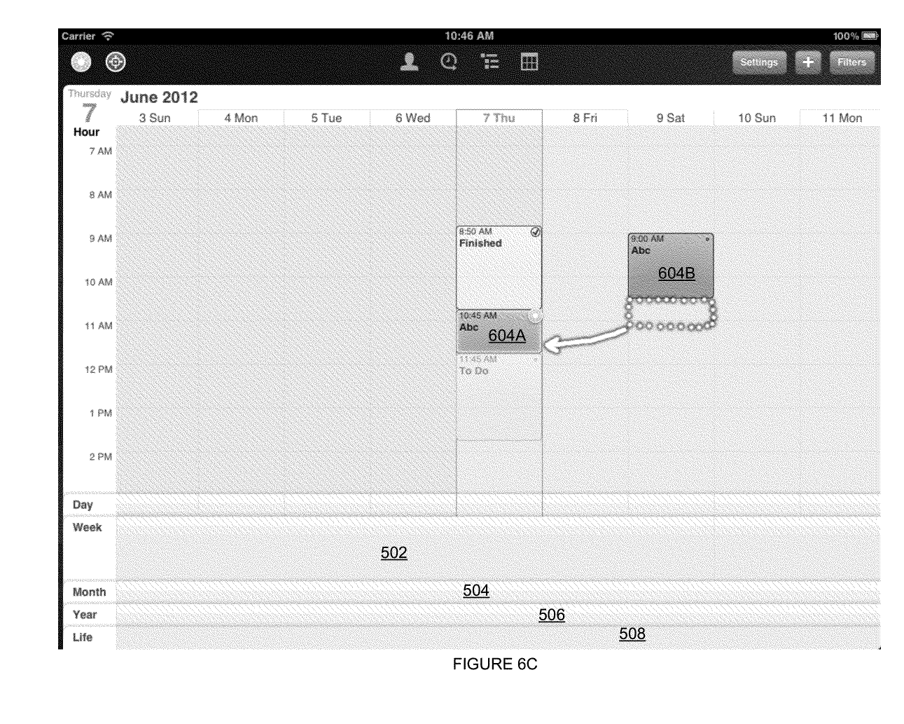

FIG. 6a illustrates a calendar view 600 whereby an available time slot 602 is shorter than a previously scheduled event 604. As per FIG. 6b, the visual representation 402 may be dragged and dropped onto event 604. As per FIG. 6c, event 604 may be partially displaced into the available time slot 602 such that event 604a corresponds to the presently available time in time slot 602 and any remaining time previously scheduled for event 604 is maintained in its original time slot as event 604b. In this embodiment, the portion of event 604 that is displaced to the present time slot 602 is taken from the bottom portion of event 604, such that event 604b begins at the same time as event 604 was previously scheduled to begin, but ends earlier. Alternatively, the portion of event 604 displaced to the present time slot 602 may be taken from the top portion of event 604, such that event 604b ends at the same time as event 604 was previously scheduled to end but starts later.

In an alternative embodiment, event 604 may be displaced into time slot 602 and instead of being partially displaced, its duration may be simply adjusted to fit into time slot 602 as event 604a without having event 604b remain in part of the previously scheduled time slot. In another alternative embodiment, event 604b may be moved into a different time period, such as any one of the week 502, month 504, year 506, and life 508 time periods. Event 604b may be displaced into the alternative time periods with its newly predefined duration associated thereto or without. Should this extra time not be needed by the user, it may be subsequently removed from the calendar view 600. Alternatively, the extra time for event 604b may be rescheduled at a later moment using the visual representation 402 as per the embodiment illustrated in FIGS. 5a-5c.

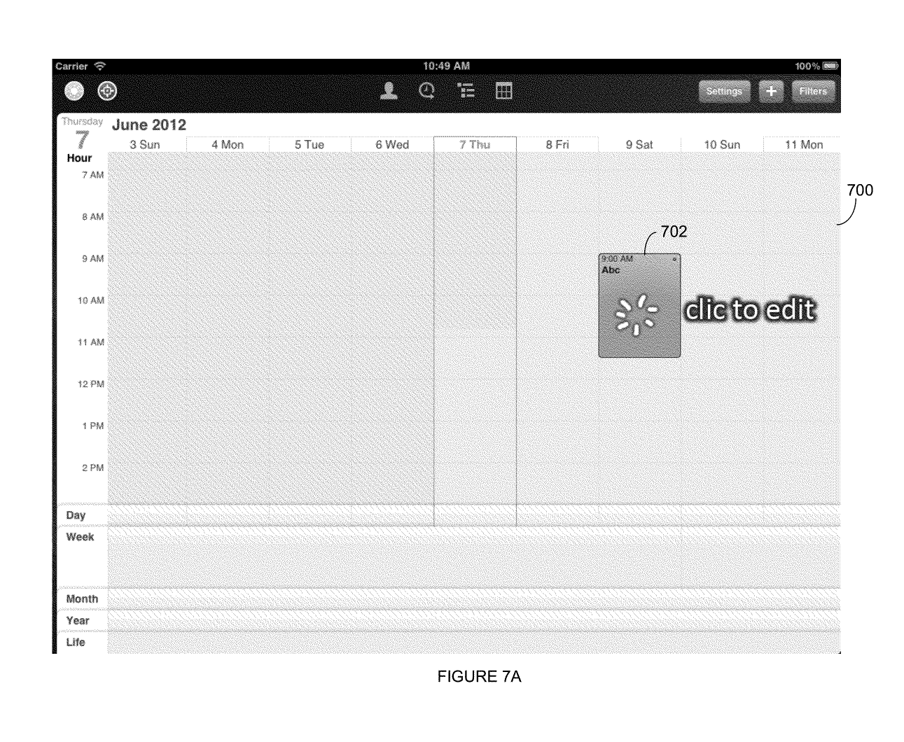

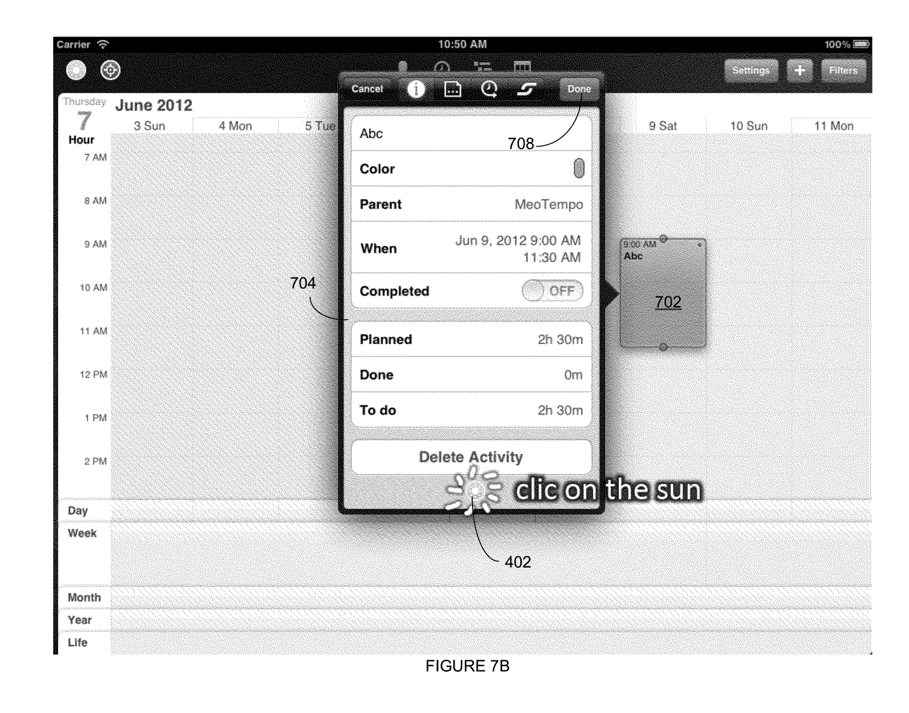

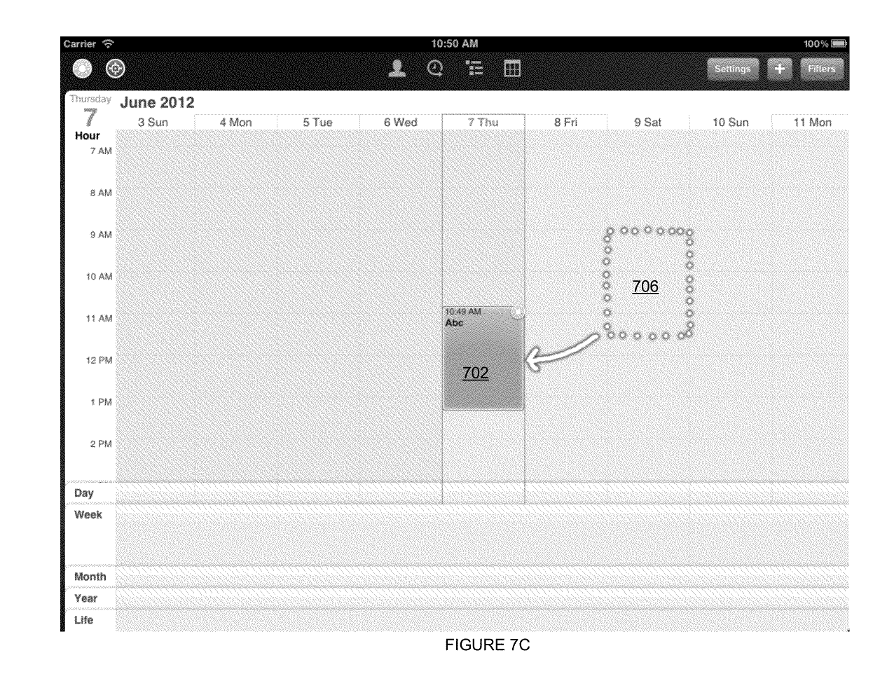

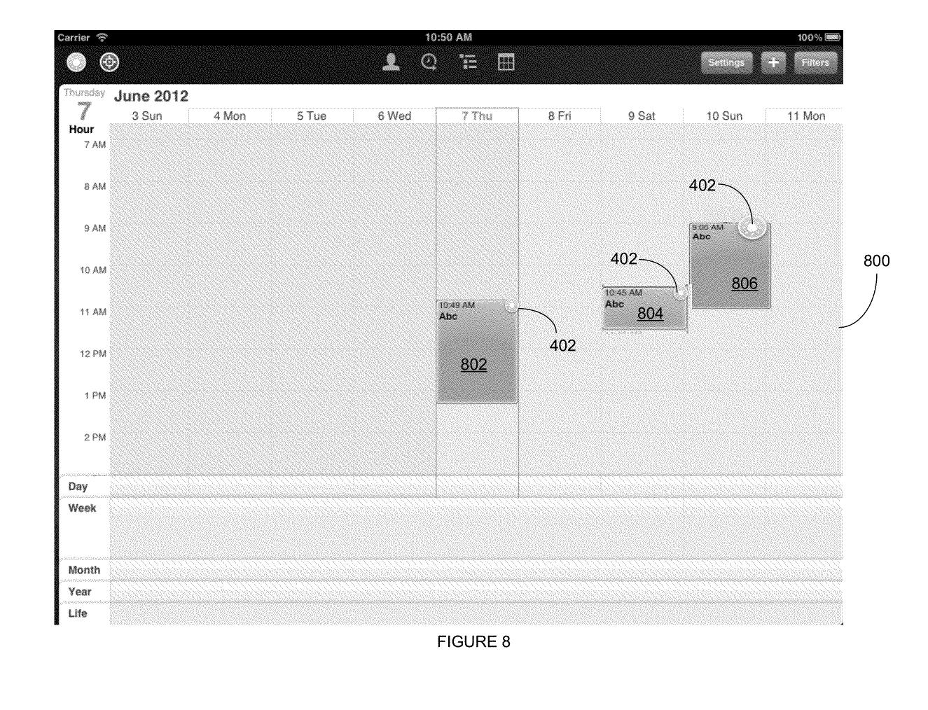

In some embodiments, other mechanisms, instead of or in addition to the drag and drop, may be provided to associate the visual representation 402 with a previously scheduled event. Referring to FIG. 7a, there is illustrated a calendar view 700 whereby event 702 may be selected for editing using an input device such as a mouse, a keyboard or a touch screen. As per FIG. 7b, selection of event 702 may cause a menu comprising a plurality of options and/or settings for the event to be displayed to the user. The visual representation 402 may be provided as part of this menu 704. Selecting the visual representation 402 may then cause the event 702 to be displaced from its previous time slot 706 to a present time, as illustrated in FIG. 7c. In some embodiments, the user may be asked to validate the selection of the visual representation 402 in the menu 704, such as by selecting a “done” option 708 on the menu 704. In another alternative embodiment, as illustrated in FIG. 8, a visual representation 402 is provided in relation to every event 802, 804, 806 at the time of creation. Selecting the visual representation 402 using any type of input device may then result in displacing the event to which it is associated to a present time slot, as described above.

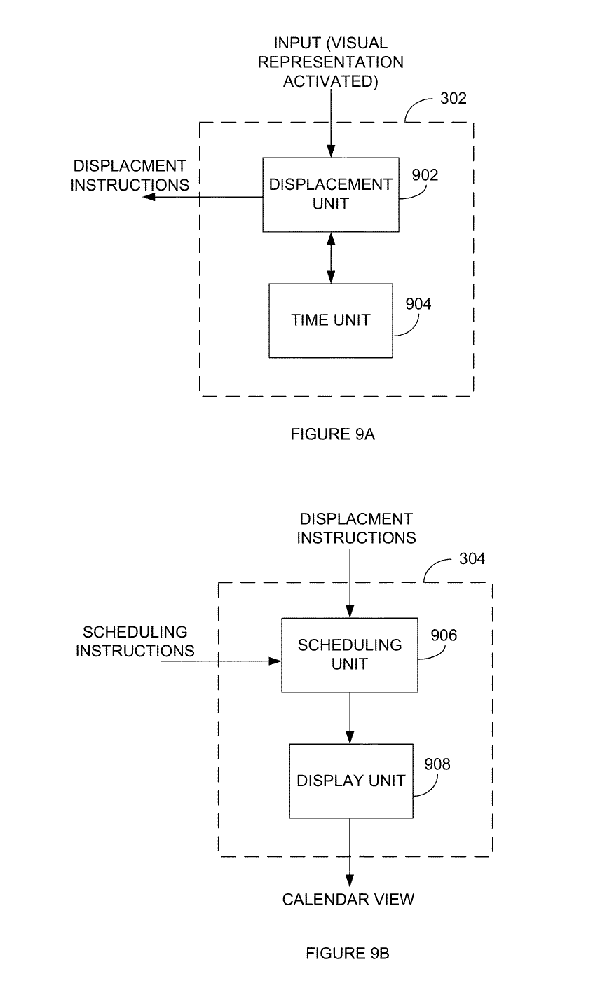

Reference will now be made to FIGS. 9a and 9b, which illustrate exemplary embodiments for the real time updating module 302 and calendar module 304, respectively. The real time updating module 302 receives an input when the visual representation 402 has been activated, i.e. it has been dropped onto a previously scheduled event, selected from a menu associated with a previously scheduled event, or selected in association with a previously scheduled event using any other known or existing selection mechanism. The input comprises at least an identification of the previously scheduled event and in some embodiments, its predefined duration. A displacement unit 902 receives the input and accesses a current time from a time unit 904. The time unit 904 may be an internal clock of the client device 102 or server 104, or it may be adapted to obtain the time upon request from an external clock, for example via network 106. Once the current time has been obtained from the time unit 904, the displacement unit 902 may generate displacement instructions for the calendar module 304 in order to cause the previously scheduled event to be displaced from its original time slot to a time slot corresponding to the retrieved present time. The calendar module 304 may received the displacement instructions at a scheduling unit 906. The scheduling unit 906 may be adapted to displace the previously scheduled event as per the displacement instructions and instruct a display unit 908 to modify the calendar view accordingly.

As previously mentioned, the calendar module 304 may be an existing module capable of receiving user instructions to create events in a calendar view and displace them as per the traditional manner of displacing such events, i.e. manually. Such user instructions may be received as scheduling instructions in a predetermined format. In one embodiment, the real time updating module 302 is an add-on component to an existing time management tool comprising the calendar module 304. The displacement instructions generated by the displacement unit 902 and received by the scheduling unit 906 may thus be provided a same predetermined format as the user instructions. The process is thus made transparent to the calendar 304 with no need to make any modifications thereto as displacement instructions received from the displacement unit 902 may be treated in a same manner as traditional user instructions to displace a previously scheduled event. Settings regarding displacing a previously scheduled event of a first duration into a present time slot of a second duration shorter than the first duration may be provided in and acted upon by the displacement unit 902.

In an alternative embodiment, the real time updating module 302 and the calendar module 304 are both custom-designed and provided as a single application. Instructions unrelated to the activation of the visual representation 402 may thus be provided in a first format while the displacement instructions resulting from interaction with the visual representation 402 may be provided in a second format different from the first format. Settings regarding displacing a previously scheduled event of a first duration into a present time slot of a second duration shorter than the first duration may be provided in and acted upon by the displacement unit 902, the scheduling unit 906, and/or a combination thereof.

In some embodiments, the present time slot is determined to the closest quarter of an hour. For example, if the current time, as determined by the time unit 904, is 11:12am, the previously scheduled event is provided in a time slot which begins at 11:15am. In another example, if the current time is 11:07am, the previously scheduled event is provided in a time slot which begins at 11:00am. Alternatively, the present time slot is determined to the closest minute and previously scheduled events may be displaced to a time slot corresponding to a current hour and minute.

In some embodiments, when a previously scheduled event is of a longer duration than a presently available time slot, subsequent events in a same time period, i.e. a same day, are bumped down to accommodate the full duration of the previously scheduled event. The user may be prompted to accept such a modification, or to select one or more of the subsequent events for modification of its duration in order to allow the previously scheduled event to be entered into the presently available time slot at its full duration.

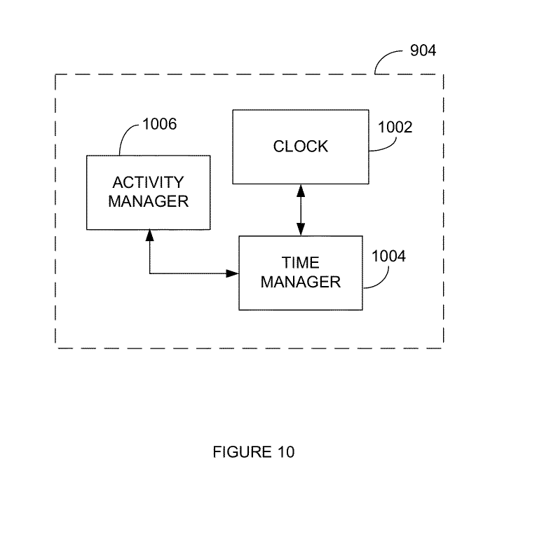

FIG. 10 is an exemplary embodiment of time unit 904. In this embodiment, in addition to a clock 1002 that functions as described above to determine an actual time, a time manager 1004 may be provided for additional time management functionalities. One such functionality is a record-keeping of scheduled time and available time for a given time period. For example, for a time period corresponding to a day, the initial available time may be twenty-four hours. After any number of events have been scheduled for the day, the duration of each scheduled event is subtracted from the initial available time to determine a remaining available time and a total scheduled time for the day. For example, if two events of four hours each are scheduled for Friday Jun. 22, 2012, the time manager 1004 will determine that the total scheduled time for the time period, i.e. the day, is eight hours and the remaining available time for the time period is sixteen hours. This information may be provided to the user on the calendar view. Similarly, remaining available time and total scheduled time may be determined for other time periods, such as the week 502, month 504, and year 506.

In some embodiments, the time manager 1004 may also be used to manage remaining available time and total scheduled time for one or more events recorded independently from the calendar, such as in a task list or other listing format that represents activities or tasks. Such events will be referred to as activities as they are independent of a specific time component indicating when they are to be performed. The activities may have a time allocation associated thereto, representing a time bank set aside or budgeted for the activity. For example, an activity may be listed as “prepare tax reports” and a block of “25 hours” may be allocated thereto. Events scheduled into the calendar view of the interactive time management tool 100 may be linked to a given activity. Linking may be done automatically using a common name when listing the activity and scheduling the event, or manually by the user by clicking on an icon or selecting an item from a menu. Other linking mechanisms may also be used.

An activity manager 1006 may be configured to work with the time manager 1004 in order to update the time allocation for a given activity to indicate a remaining available time whenever an event for a corresponding activity is entered into a time slot in the calendar. For example, if an event related to “prepare tax reports” has been scheduled for one hour this week and one hour next week, the activity “prepare tax reports” may indicate the initial available time as 25 hours, the remaining available time as 23 hours, and the total scheduled time as 2 hours.

In some embodiments, the initial available time allocated to an activity is locked and cannot be increased beyond this amount. If a user attempts to schedule a new event in the calendar for a duration of time beyond the remaining available time for the corresponding activity, the user may be advised that there is insufficient time remaining in the time bank for the activity. Alternatively, the activity manager 1006 may allow the total scheduled time to exceed the initial available time. In some embodiments, the remaining available time may be indicated using a negative value, such as −2 hours, when the total scheduled time exceeds the initial available time by 2 hours.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. It should be noted that the present invention can be carried out as a method, can be embodied in a system, or on a computer readable medium. The embodiments of the invention described above are intended to be exemplary only. The scope of the invention is therefore intended to be limited solely by the scope of the appended claims.

1. An interactive time management system comprising:
a processor in a computer system;
a memory accessible by the processor; and
at least one application stored in the memory and having program code executable by the processor for:
receiving as input an identification of a previously scheduled event in a calendar view of an electronic calendar;
determining in real time a current time;
identifying a current time slot in the calendar view corresponding to the current time; and
generating a displacement instruction to displace the previously scheduled event in the calendar view to the current time slot.

2. The system of claim 1, wherein generating the displacement instructions comprises generating duration instructions for a default duration.

3. The system of claim 1, wherein receiving as input comprises receiving a predefined duration of the previously scheduled event.

4. The system of claim 3, wherein the program code is further executable by the processor for:
comparing the predefined duration of the previously scheduled event to a duration of the current time slot; and
generating the displacement instructions with duration instructions to displace the previously scheduled event to the current time slot for a modified duration.

5. The system of claim 4, wherein the modified duration corresponds to the duration of the current time slot.

6. The system of claim 5, wherein the program code is further executable by the processor for generating updating instructions to set the previously scheduled event in an initial time slot to an updated duration corresponding to a difference between the predefined duration and the modified duration.

7. The system of claim 1, wherein the program code is further executable by the processor for:
providing a visual representation in the calendar view; and
receiving as input the identification of the previously scheduled event when the visual representation has been activated in association with the previously scheduled event.

8. The system of claim 7, wherein receiving as input the identification of the previously scheduled event comprises determining that the visual representation has been dragged from an initial position and dropped onto the previously scheduled event.

9. The system of claim 7, wherein receiving as input the identification of the previously scheduled event comprises determining that the visual representation has been selected from a menu associated with the previously scheduled event.

10. A computer-implemented method for interactive time management of an electronic calendar comprising execution of program code for:
receiving as input an identification of a previously scheduled event in a calendar view of the electronic calendar;
determining in real time a current time;
identifying a current time slot in the calendar view corresponding to the current time; and
generating a displacement instruction to displace the previously scheduled event in the calendar view to the current time slot.

11. The method of claim 10, wherein generating the displacement instructions comprises generating duration instructions for a default duration.

12. The method of claim 1, wherein receiving as input comprises receiving a predefined duration of the previously scheduled event.

13. The method of claim 12, further comprising execution of program code for:
comparing the predefined duration of the previously scheduled event to a duration of the current time slot; and
generating the displacement instructions with duration instructions to displace the previously scheduled event to the current time slot for a modified duration.

14. The method of claim 13, wherein the modified duration corresponds to the duration of the current time slot.

15. The method of claim 14, further comprising execution of program code for generating updating instructions to set the previously scheduled event in an initial time slot to an updated duration corresponding to a difference between the predefined duration and the modified duration.

16. The method of claim 10, further comprising execution of program code for:
providing a visual representation in the calendar view; and
receiving as input the identification of the previously scheduled event when the visual representation has been activated in association with the previously scheduled event.

17. The method of claim 16, wherein receiving as input the identification of the previously scheduled event comprises determining that the visual representation has been dragged from an initial position and dropped onto the previously scheduled event.

18. The method of claim 16, wherein receiving as input the identification of the previously scheduled event comprises determining that the visual representation has been selected from a menu associated with the previously scheduled event.

19. A non-transitory computer readable medium having stored thereon program code executable by a processor for interactive time management of an electronic calendar, the program code executable for:
receiving as input an identification of a previously scheduled event in a calendar view of the electronic calendar;
determining in real time a current time;
identifying a current time slot in the calendar view corresponding to the current time; and
generating a displacement instruction to displace the previously scheduled event in the calendar view to the current time slot.

20. The computer readable medium of claim 19, wherein the program code is further executable for:
providing a visual representation in the calendar view; and
receiving as input the identification of the previously scheduled event when the visual representation has been activated in association with the previously scheduled event.
